(19) United States
(12) Patent Application Publication
(10) Pub. No.: US 2007/0250514 A1
(43) Pub. Date: Oct. 25, 2007

(54) Browsing and monitoring the web through learning and ingemination

(76) Inventors: Saeed Rajput, Port St. Lucie, FL (US); John Hruska, Stuart, FL (US)

Correspondence Address: MCHALE & SLAVIN, P.A., 2855 PGA BLVD, PALM BEACH GARDENS, FL, 33410, US

(21) Appl. No.: 11/411,188

(22) Filed: Apr. 25, 2006

(51) Int. Cl. G06F 17/30; G06F 7/00

(52) U.S. Cl. 707/10

(57) ABSTRACT

Information retrieval and consumption from the web is becoming the fundamental way we manage our lives, business and leisure. To simplify retrieving information of our interest, a lot of research has been done in the area of web crawlers, or “bots” that navigate the web automatically, read web pages, and index those web pages based on the content of web pages. Another group of utilities that monitor web page changes have also emerged. Web crawlers provide very little control to the users in the manner in which the web is navigated and they fail to work with links that have links embedded in scripts. The web page monitoring applications fail when the pages are dynamically generated, and the links to the pages change all the time. Furthermore more and more content is being protected by authentication schemes such as username and password based authentication. These issues make the conventional web navigation automation tools ineffective for most useful applications. This innovation deals with these issues by providing interactive approach to learn the navigation and then repeat the learn sequence of actions, while monitoring for the changes in the values.

### COPYRIGHT AUTHORIZATION

A portion of the disclosure of this patent document contains material that is subject to copyright protection. The copyright owner has no objection to the facsimile reproduction by any one of the patent disclosures, as it appears in the U.S. Patent and Trademark Office patent files or records, but otherwise reserves all copyrights whatsoever.

### 1 FIELD OF THE INVENTION

The field of the present invention relates in general to the web data mining where information is collected from the web automatically for benefit of individuals and institutions. More particularly the field of invention relates to learning a sequence of action performed by users when navigating the web and be able to repeat those actions precisely later.

### 2 BACKGROUND

Information retrieval and consumption from the web is becoming the fundamental way we manage our lives, business and leisure. Web has simplified the manner in which we find information, fined directions, reserve our trips, manage our finances, pay our taxes, pay our bills, etc. Due to real time information available on the web, it is possible to monitor our personal information continuously, but it can be time consuming. Furthermore, due to dispersed nature of information on the web, the amount spent on clicking mouse buttons in retrieving that information is increasing.

To simplify retrieving information of our interest, a lot of research has been done in the area of web crawlers, or “bots” that navigate the web automatically, read web pages, and index those web pages based on the content of web pages. These crawlers are designed to jump from one page to another through URL links embedded in the pages.

Another group of utilities that monitor web page changes have also emerged. These utilities remember the contents of the web page to be monitored; they visit the webpage at pre-determined schedule, and detect any changes in the page from last visit. If a change meets the predefined conditions, an alert is sent to the user. This way the user is relieved from the burden of having to continuously monitor the webpage by themselves.

Web crawlers provide very little control to the users in the manner in which the web is navigated. Furthermore, they fail to work with links that have links embedded in javascript, or pages that require password based authentication.

The web page monitoring applications only monitor separate pages that are relatively static. Most modern applications create dynamically changing pages, and the links to the pages are also changing all the time. Furthermore more and more content is being protected by authentication schemes such as username and password based authentication.

These issues make the conventional web navigation automation tools ineffective for most useful applications.

### 3 SUMMARY OF THE INVENTION

Information retrieval and consumption from the web is becoming the fundamental way we manage our lives, business and leisure. To simplify retrieving information of our interest, a lot of research has been done in the area of web crawlers, or “bots” that navigate the web automatically, read web pages, and index those web pages based on the content of web pages. Another group of utilities that monitor web page changes have also emerged. Web crawlers provide very little control to the users in the manner in which the web is navigated and they fail to work with links that have links embedded in scripts, or pages that require password based authentication. The web page monitoring applications fail when the pages are dynamically generated, and the links to the pages change all the time. Furthermore more and more content is being protected by authentication schemes such as username and password based authentication. These issues make the conventional web navigation automation tools ineffective for most useful applications. This innovation deals with these issues by providing interactive approach to learn the navigation and then repeat the learn sequence of actions, while monitoring for the changes in the values.

The invention allows user to first learn a sequence of user actions as she interacts with the browser, and provides facility to save these learned sequences in an organized manner. Any data entered into forms during this sequence of actions is also saved. On any of the pages during this learning process, the user can highlight certain elements of the webpage and mark them to be part of monitors. In addition to containing references to the marked elements in the web page, monitors also contain user-defined conditions. The stored sequence can subsequently be ingeminated (repeated) automatically based on a preprogrammed schedule. The sequence can also be repeated based on user request with full visual display speed of which can be controlled by the user or it can repeated one action at a time in a single step mode. During the repeating of the sequence, the monitors watch for the elements that have been marked. If any of the conditions defined in the monitor is satisfied, the user is alerted using one or some of the preconfigured methods.

### 4 BRIEF DESCRIPTION OF DIAGRAMS

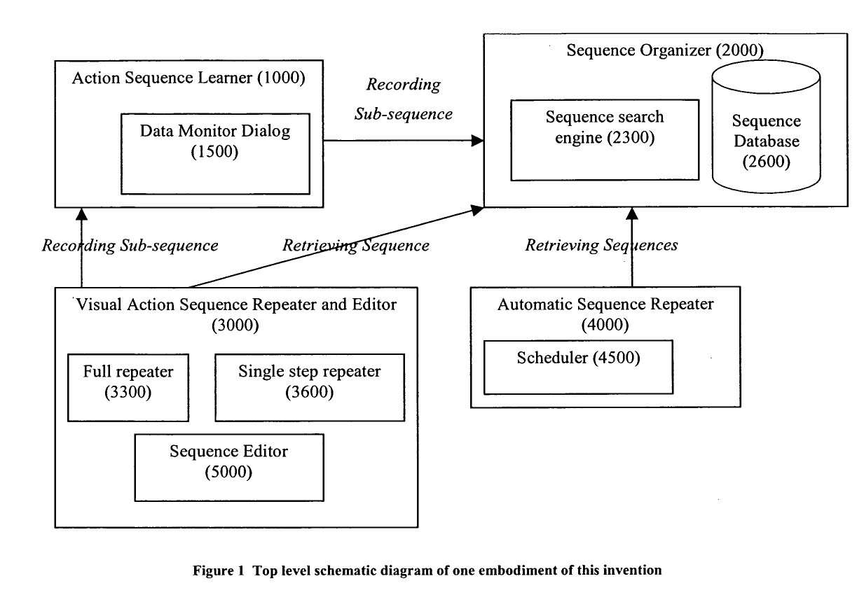

FIG. 1 shows the top-level schematic diagram of one embodiment of the invention. The diagram shows four main components;

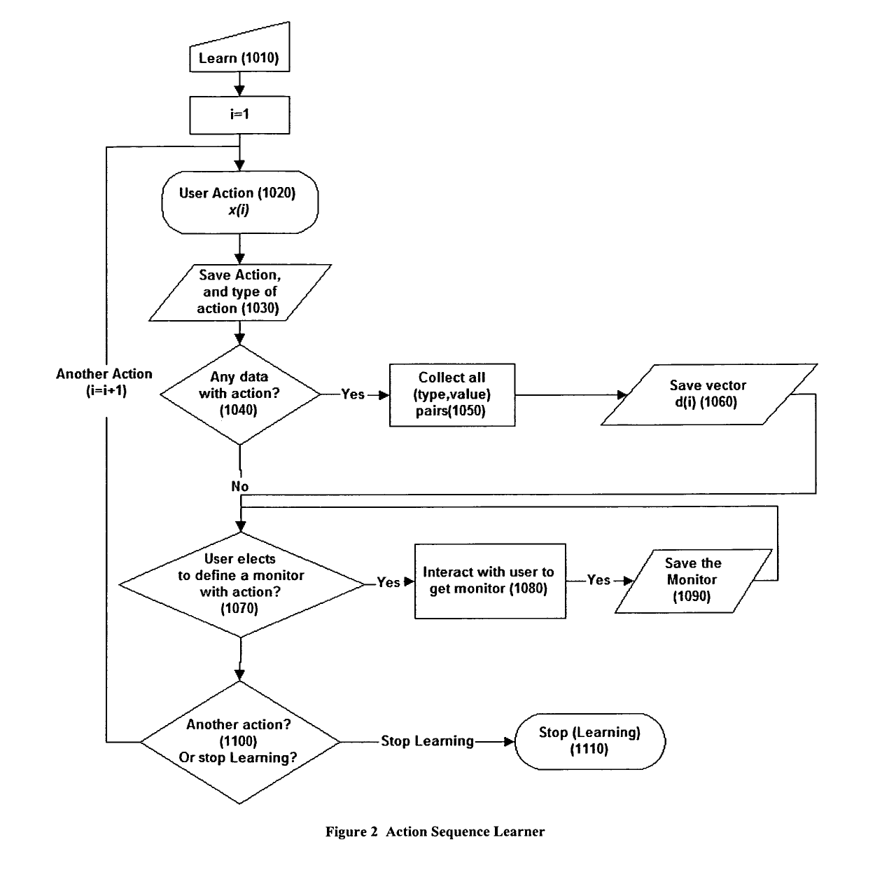

FIG. 2 shows the flow chart of action sequence learner that is one of the components of the embodiment of the invention. It shows how the user interacts with the embodiment;

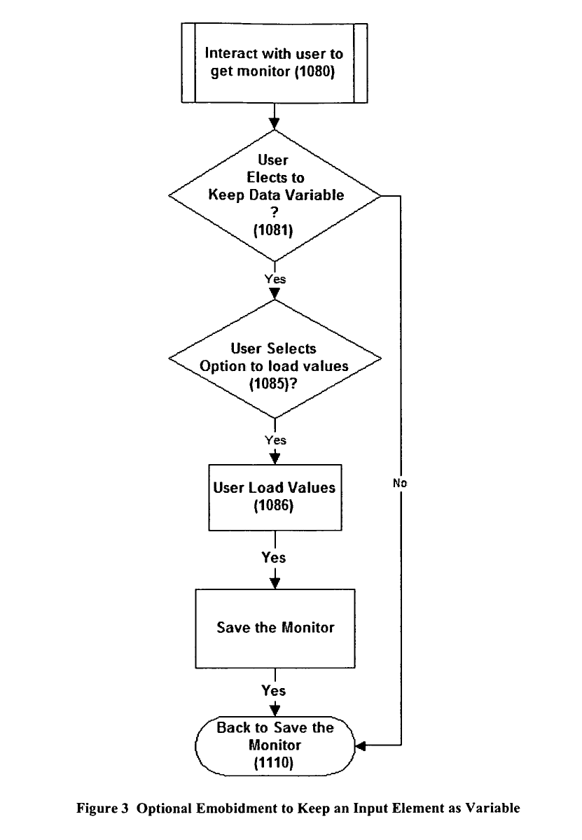

FIG. 3 shows an alternative embodiment in which the an input form element is kept as variable;

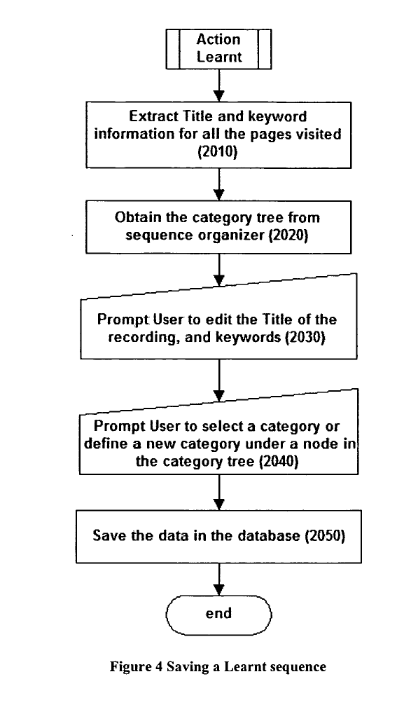

FIG. 4 shows how a learnt sequence is saved and categorized by the embodiment so it can be easily located subsequently. The figure depicts using a flow chart approach.

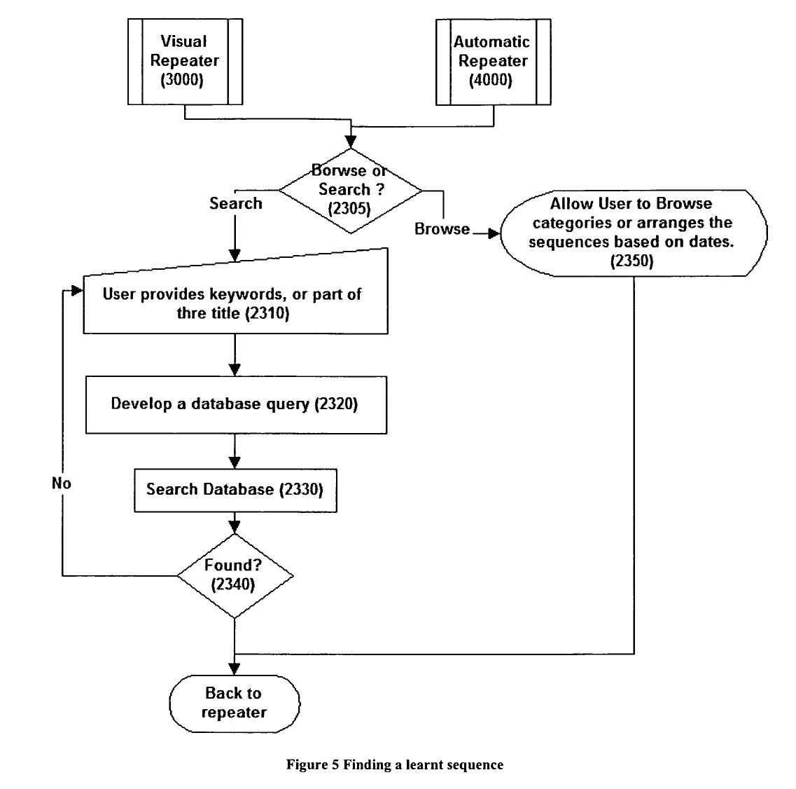

FIG. 5 depicts how the embodiment helps user to retrieve learnt sequence that was previously learnt from the database.

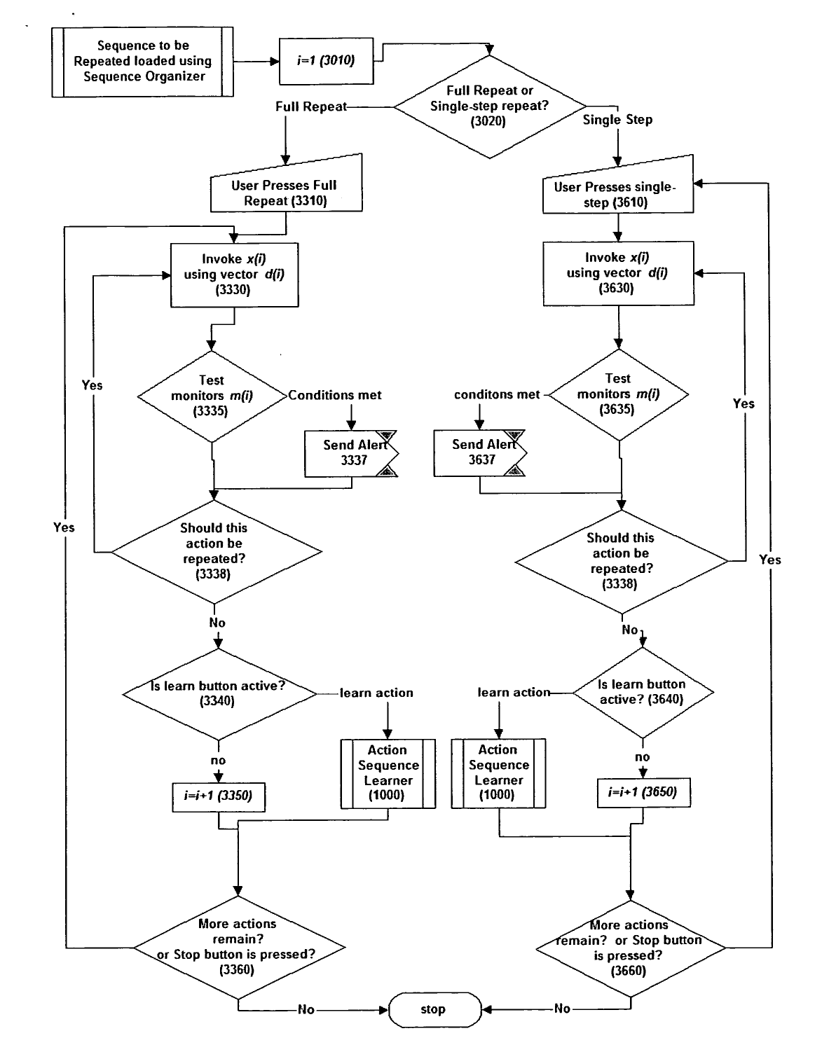

FIG. 6 shows how the embodiment allows user to visual repeat the sequence of action from the saved sequence, so that the user can confirm the correctness of the sequence. As clear from this diagram, the user have two options: 1) full repeat and single step repeat. This diagram also shows that user can use this approach to re-learn subsequences from an already recorded sequence.

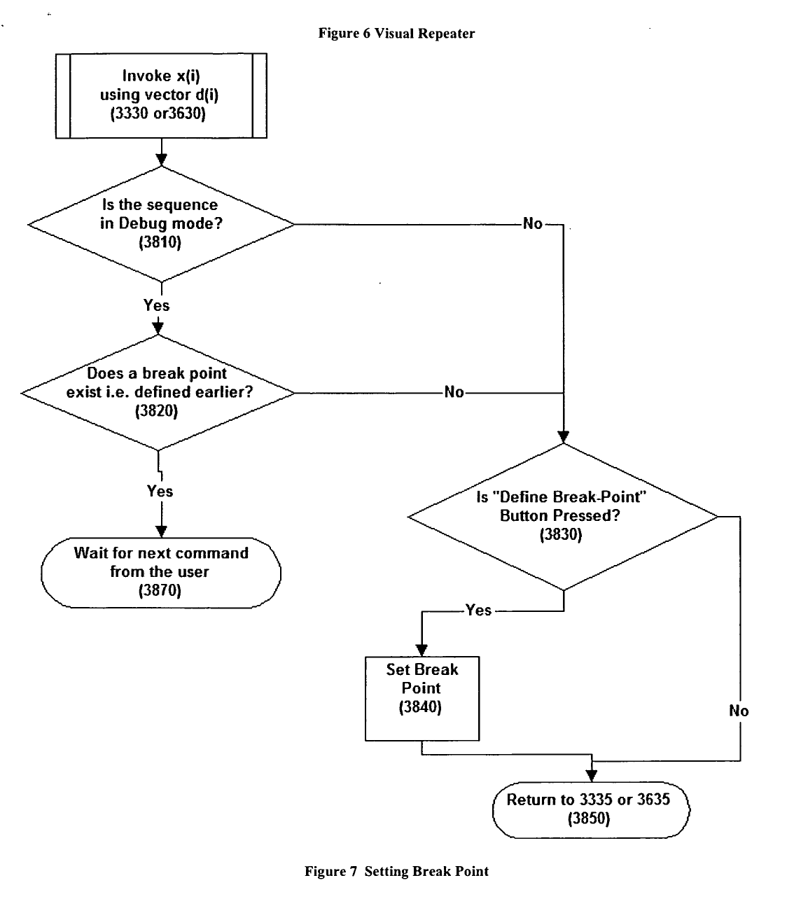

FIG. 7 depicts the details of inside action during the repetition that deals with a break point or allows user to insert a break point during a repetition of the sequence.

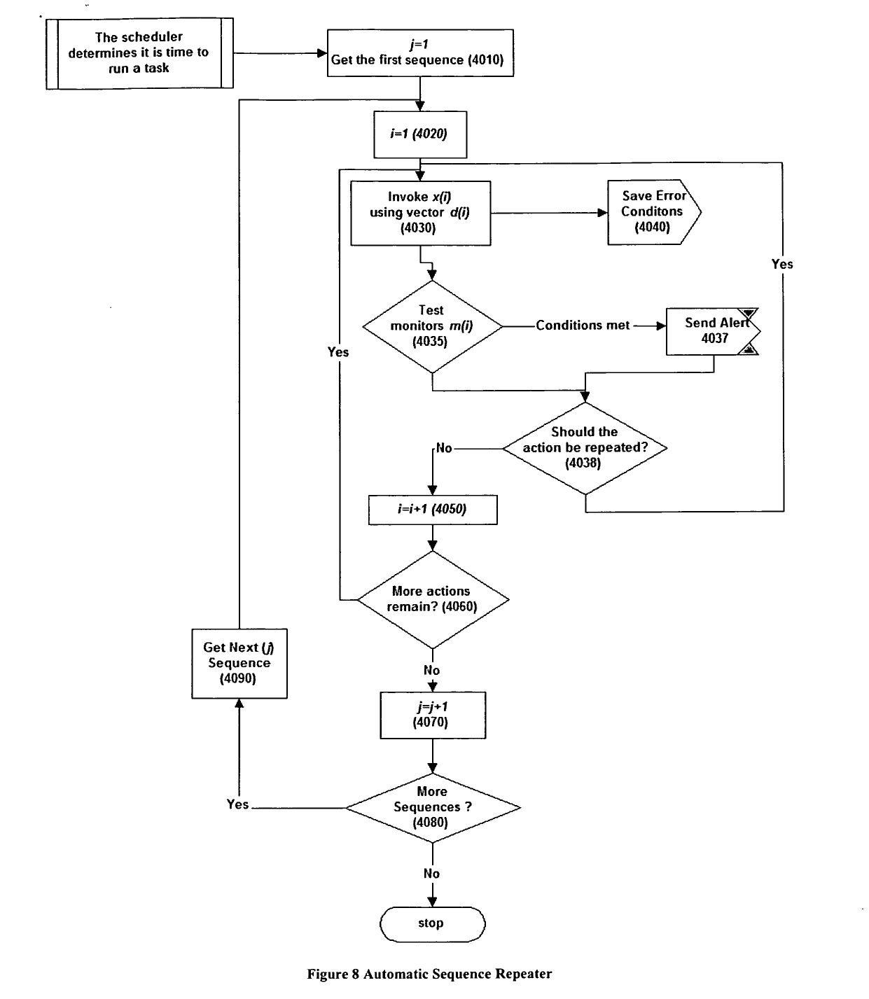

FIG. 8 shows how the embodiment allows user to repeat a group of sequences automatically based on a pre-defined schedule.

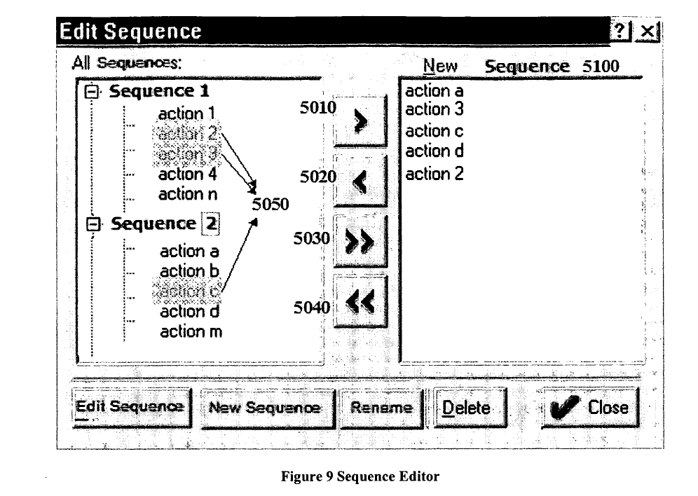

FIG. 9 provides the user interface for the sequence editor that allows user to create new sequences based on existing sequences.

### 5 DETAILED DESCRIPTION

FIG. 1 shows the schematic diagram of one embodiment of this invention. This embodiment is composed of four main components: 1) user actions sequence learner (1000), 2) learned sequence organizer (2000), 3) visual user action repeater and editor (3000), and 4) automatic user action ingemination engine or the repeater (4000).

5.1 Action Sequence Learner

The invention provides the facility to learn the sequence of actions (see FIG. 2) of the user [xᵢ]ᵢ₌₁ⁿ, where xᵢ is the i^{th} action. Each action may be accompanied by a vector of data \vec{d}ᵢ, where \vec{d}ᵢ=[dᵢ₁ dᵢ₂ . . . dᵢₘ_{ᵢ}] and dᵢⱼ is a type-value pair i.e. dᵢⱼ=(tᵢⱼ,vᵢⱼ). The data vector \vec{d}ᵢ contains the information added by the users into the html forms before action xᵢ. More commonly, xᵢ is a button or a link on the web page that the user clicks. Therefore each action xᵢ is also associated with an action type aᵢ where aᵢεA, and A is a finite set of action types. The vector \vec{d}ᵢ can be empty when there is no data associated with an action. The invention defines a specific format in which xᵢ and associated data are stored. For every webpage visited during this sequence learning process, the embodiment also allows user to define monitors that watch specific elements on a webpage for changes. During this process, the user can define conditions as defined in Section 6. For each monitor the user can also define several optional notifications techniques defined in Section 6.1. The monitors are also associated with the actions. Therefore, each action is also associated with a vector of monitors \vec{m}ᵢ, Thus, each action xᵢ is associated with <aᵢ, \vec{d}ᵢ, \vec{m}ᵢ>.

This information is store in a database, while alternative embodiments can store this information in a file format. The saved information is encrypted so it can only be decrypted if the user provides a decrypting password.

An embodiment of the invention comprises of a specialized browser that provides same look-n-feel of a regular Internet browser. In addition to providing the user will complete browsing capabilities, it provides learning and repeating facilities. When the user desires, she can start the learning process 1010 (see FIG. 2) and all the subsequent actions 1020 will be learned and saved as a sequence [x_{i]}ᵢ₌₁ⁿ 1030. For each action the data vector \vec{d}ᵢ is also saved 1040, 1050, 1060. After each action, the user can define one or more monitors. These monitors are saved as a vector \vec{m}ᵢ as well 1070,1080,1090. One example of this data vector has two elements: dᵢ₁=(“userName”, value), dᵢ₂=(“password”, value) 1050 that records the user name and password entered by the user. Other data vectors may include other values provided for the forms. The learning can be stopped by presses the stop button 1070, 1080.

5.2 Sequence Organizer

When a sequence [xᵢ]ᵢ₌₁ⁿ has been learned, it must be archived in a manner that it is easily searchable (see FIG. 4). The embodiment of this invention then extracts title, and keywords from HTML tags, and the URL of the all the pages involved in sequence 2010. When a learning process is completed, the user is presented with a dialog box that shows editable value for “Title” (obtained from the first html page), un-editable URL of the first page, editable list of keywords from the html header of the all html pages 2030. This embodiment of this invention also obtains the category tree 2020 and provides a button that the user can click to see the category tree. User can browse to get to a category or can “create” a new category at any level in the category hierarchy 2040. This embodiment of the invention uses all the titles and keywords saved for keyword-based searches together with this record.

The categories are organized in a hierarchical manner.

When displaying the learned sequences, the user can locate the sequence based on the date 2305,2350 on which the sequence was learnt, the title of the first page, URL of the first page, or the categories 2305.

A search box can also be used to do sub-string searching on the title, or keywords 2310,2320,2330.

A facility is provided for the user to manage categories so that user can modify the manner in which categories are arranged.

5.3 Visual User Action Repeater

Once at least one sequence [xᵢ]ᵢ₌₁ⁿ has been made, this embodiment of invention allows the user to repeat these actions in exactly the same order as they were invoked during learning. This can be done over and over again without the need for the user to be present.

To replay the sequence the user first has to locate the sequence using the sequence organizer either hierarchically or through search. After the sequence is located, user can press the “repeat” button to repeat the steps in this sequence. The embodiment of this invention provides two options 3010 for the user to repeat the sequence visually: 1) Full repeat, and 2) Single-Step repeat. During any of the repeating modes, if any of the conditions of the monitors are satisfied, an alert will be sent based on the notification options that user has selected as defined in section 6.1. During replay this embodiment allows user to place a break-point 3830, 3840 at any action.

5.3.1 Extracting Portion of a Sequence Saved Earlier and Merging Sequences

The embodiment of this invention provides a method of extracting a number of continuous actions in the sequence [xᵢ]ᵢ₌₁ⁿ, e.g. a new sequence can be created [\hat{x}ₗ]ₗ₌₁^{l=k}^{₂}^{k}^{₁}⁺¹=[xᵢ]ᵢ₌ₖ_{₁}^{k}^{₂} where \hat{x}₁=xᵢ₋ₖ_{₁}₊₁. The data vectors are copied to the new sub-sequence in obvious manner. The process of this described while we describe the user interface of visual repetition of sequence.

5.3.2 Full Repeat Mode

When the user presses the full repeat button 3310, the single step button is disabled and the embodiment of this invention is able to repeat the same sequence back to user in visual manner so the user can confirm that the browsing is correctly learnt 3330, 3350,3360.

During this ingemination, all the monitors for each action are also tested 3335 against the conditions that are defined for them. If any or some of the monitors' conditions are satisfied, notifications are sent out to the user 3337. If the monitor indicates that this action is to be repeated with a certain frequency, the action is repeated 3338.

During the full repeat mode, the learn button remains enabled. If the user presses this learning button 3340, a separate file to save the activity sub-sequence [\hat{x}ₗ]ₗ₌₁^{l=k}^{₂}^{-k}^{₁}⁺¹, is created starting from that point onwards. The learning button changes name and color to “stop learning” button. At this time if the “stop learning” is pressed the learning is stopped 1080.

Pressing the stop button stops the sequence at the current location 3360.

The full repeat mode also has a debug mode 3810, in which if the sequence has a break point 3820, the repetition halts 3870 at the location of the back point and wait for user to issue further instruction through the user interface.

5.3.3 Single Step Repeat

After the learning if the user presses the single step button 3610, the full repeat button is disabled, and action x₁ is invoked and \vec{d}₁ is used if it is not empty 3630, 3650,3660.

When the user presses single step button 3610 again, and action x₂ is invoked and \vec{d}₂ is used if it is not empty 3630,3650,3660.

Similarly, subsequently after invoking action xₖ single step button is pressed, action Xₖ₊₁ is invoked and the data \vec{d}ₖ₊₁ is used if not empty 3630, 3650,3660.

During this ingemination, all the monitors for each action are also tested 3635 against the conditions that are defined for them. If any or some of the monitors' conditions are satisfied, notifications are sent out to the user 3637. If the monitor indicates that this action is to be repeated with a certain frequency, the action is repeated 3638.

The learning button remains enabled. When the user presses the learning button 3640, it changes name to “stop learning” and a new learning sequence starts from that point onwards. This learning sequence will stop only when the user presses the “stop learning” button 1080.

To stop the single step repeat, the stop button has to be pressed 3660.

5.4 Visual Sequence Editor

The embodiment of the invention provides a visual sequence editor to facilitate removal of specific action 5020 or multi-selected group of actions 5040 from the sequence, transfer of specific action or multi-selected group of actions from other sequences 5010, 5050, and merging of multiple sequences into a new single sequence 5100.

5.5 Automatic Repeat Mode

A scheduler is provided to schedule for repeating the learnt sequences automatically. The scheduler defines tasks and allows the user to select one sequence or to select multiple sequences by using check boxes on individual sequences or entire categories, to be scheduled as a task for specific time and frequency. The scheduling options can be one or more of the following: 1) run only once at a specific time and data, 2) run periodically after every configured number of minutes, 3) run on specific days of the week at specified times, every week, 4) monthly on a specified day at specified time, 5) run yearly on specified time and day.

Multiple tasks can be established.

The scheduler launches the sequences at the predetermined schedule (see FIG. 8). All the sequences that are part of a scheduled task will be repeated one at a time 4010. Predetermined actions 4020, 4030, 4050, 4060 will be taken after the recoding has been played

During this ingemination, all the monitors for each action are also tested 4035 against the conditions that are defined for them. If any or some of the monitors' conditions are satisfied, notifications are sent out to the user 4037. If the monitor indicates that this action is to be repeated with a certain frequency, the action is repeated 4038 when the conditions of repetition are satisfied. Otherwise the embodiments waits for the conditions to be satisfied.

If a action returns an error condition, it is reported in an alert 4040.

It will read a recorded file and will be able to repeat the action of the user mimicking the browser. Options will be provided to control the speed of the browser, and some level of randomization to avert detection by web-crawler detection devices.

The above steps will be repeated for all the sequences 4080, 4090.

During this repeating mode, if any of the conditions of the monitors are satisfied, an alert will be sent based on the notification options that user has selected as defined in section 6.1.

5.6 Repeating with Different Form Elements

An alternative embodiment of this invention allows user to indicate form elements on a webpage during the sequence learning, that must be kept as variable. To do so, during the recording, after any action user is allowed to indicate a form element that must be kept as variable 1081. The embodiment provides a user interface for the user to indicate the form element whose value must be kept variable. The user interface will also allow the user to opt for manual entry at the time of visual ingemination, that the visual ingemination will pause for user to type in that value, or the user can opt 1085 to provide possible values that must be used one after the other by uploading those values in form of a file or a database 1086. The embodiment associates those values with the action after which this happens and save the values along with the sequence. During automatic replay the list of values is used one by one, one value for one repetition of the entire sequence 3335, 3635.

### 6 MONITORING

This embodiment of the invention provides the facility to monitor specific values on a particular webpage. When the values change to exceed predefined conditions, an alert is send to the user or system that wants to monitor that value, or a log entry is created in the database. This invention also provides the facility to monitor multiple web pages, and the alert can be based on aggregated policy on the multiple web pages.

On a particular webpage, a GUI embedded into the browser allows user to select a value to be monitored.

The user is able to highlight the name of a value, or the value itself, and the embodiment identifies the location of that value. The embodiment identifies how to locate that value in future, when the page is revisited.

The user enters the conditions under which the alert is issued or a log entry is made, and a scheduled based on how often the webpage must be visited, to check the value. The schedule can be one or more of the following options: 1) run only once at a specific time and data, 2) run periodically after every configured number of minutes, 3) run on specific days of the week at specified times, every week, 4) monthly on a specified day at specified time, 5) run yearly on specified time and day.

The conditions include the following:

Range: If the value goes out of this range an alert is issued.

Change: Any change in the value is notified

Addition of a new entry in a table or a list

Absence of the element

Change in Location of the element

Frequency of change

Filtering of changes using keywords for elements that are strings or have strings in their list so that the monitor is triggered only when the keywords occur, or do not occur, thus filtering the number of alerts based on these numbers.

Alert when page access fails

Watch for new links on a Web page.

Frequency at which the value is to be monitored, and the number of times the monitoring is to be repeated by refreshing the page over and over again.

Embodiment provides the facility to import sequence learnt on other computers and export its own sequences individually and as a group (entire category—recursively). This facility can also be used to exchange sequences with other users on other machines.

The embodiment provides an option of preserving the state of the every webpage by saving the original page, creating a pdf or image snapshot version of each page, and also keeping a text image of the page (to track the changes). User can select the number of versions of the web pages versions to be saved. An alternative embodiment saves the original webpage as well.

The embodiment also provides the feature of detecting the changes in an image from last time that image was visited provided the user has marked that image to be monitored.

After an entire sequence is learnt, the embodiment allows the user to define a compound condition based on multiple web pages that are part of this sequence.

The embodiment of this invention monitors the website(s) for which a learnt sequence exists by visiting as determine by the frequency of any of the values to be monitored in that sequence. When the web page is visited, the value is observed and if the defined conditions are met, the changes are recorded an alert is issued or a log entry is made into the database as configured. The compound conditions are also tested.

Once a sequence has been recorded and the elements to be monitored have been marked, the embodiment retains versions of the web pages that have been marked, and at every subsequent visit, the changes are identified. If the changes satisfy the conditions under which an alert must be issued, an alert is issued based on preconfigured notification methods defined below.

The embodiment of the invention continuously visits every stored sequence and checking the scheduled conditions on every monitor associated with all the actions in that sequence. When any of these monitors indicates that its scheduling conditions are met, that sequence is placed on a queue of to-be-repeated sequences. The embodiment also continuously visits this queue of to-be-repeated sequences and repeats the sequences in this queue one after the other. The sequence that has been repeated is taken off this queue.

6.1 Notification Options

Following configuration options are provided for alerts:
Log only: that logs the event into a even database
Alert by e-mail: which sends out the alert to users based on pre-configured e-mail addresses.
Sending alert by remote message send to a remote machine based on any network protocol including RPC, RMI, CORBA, HTTP, SAOP, or Web Services,
Alert by a popup dialog box on the local machine
Invoking an application on the local machine or remote machine.

Specify the number of changes to occur before a notification is sent.

Specify a set of keywords to occur in the changed text. For example, if you are looking for job with the key word “technical writer” in the description, you may specify this as the keyword phrase. You can enter multiple keywords and specify whether all of them should occur in the changed text or any of them may occur.

1. A method of learning a sequence of user actions while the user is browsing the web through the application that user uses to browse, and saving these actions in a file for later use, the method comprising the steps of:
determining the type of the action;
capturing the data provided by the user if the action requires user data to be provided as a vector of type-value pairs;
saving the action type and the data vector in a file or database and optionally encrypting the information before saving.

2. The method of 1, including steps of:
wherein all the URLs, titles, and all the keywords of all the web pages visited during the learning process are remembered and displayed to the user, and
the user is allowed to modify keywords;
this identifying information is associated with the sequence and saved as well.

3. The method of 1, wherein the user is provided a user interface to select a category in a category tree, or to create a new category under an existing category node in the tree and save the learnt sequence along all associated data vectors.

4. The method of 1, wherein after every action, the user can create a monitor for absence of the page or for the presence of new elements, or a monitor for any of the existing elements on that web including the steps of:
defining the binary conditions on the element such as 1) detection of any change, 2) absence of the element and 3) change of location of the element;
defining a range for the value of the element so that if the element is out that range the monitor is triggered;
new entry into the element if the element of type list;
frequency of change;
define keywords for elements that are strings or have strings in their list so that the monitor is triggered only when the keywords occur, or do not occur, thus filtering the number of alerts based on these numbers;
define the notification options such as 1) log only which logs the event into a even database, 2) alert by e-mail, which sends out the alert to users based on pre-configured e-mail addresses, 3) alert by remote message send to a remote machine based on any network protocol including RPC, RMI, CORBA, HTTP, SAOP, or Web Services, 4) alert by pop-up dialog box on the local machine, and 5) invoking an application on the local machine or remote machine;
defining a frequency at which a particular action should be repeated and corresponding value be monitored, and the number of times the monitoring is to be repeated by refreshing the page over and over again;
associating all the monitors immediately following an action with the action as a vector, and saving the all the monitor vectors with the sequence.

5. The method of 1, wherein after learning the entire sequence, the user can create compound monitors based on monitors defined as claimed in claim 4.

6. The method of 1, wherein after any action the user is allowed to indicate a form element that must be kept as variable and it will include the steps of:
providing a user interface for the user to indicate the form element those value must be kept variable;
provide user the option to select manual entry at the time of visual replay;
ask the user to provide possible values that must be used one after the other. User will be allowed to upload those values in form of a file;
associating those values with the action after which this happens and save the values along with the sequence.

7. A method of repeating the sequence of actions where the entire navigation is repeated for the user by reading the actions and data vector already stored in the file, the method comprising the steps of:
reading the actions, data vector and monitors associated with the sequence. If the data was encrypted, taking appropriate measures to decrypt the data;
invoking the same type of actions that user originally invoked;
populating the data read from data vector into requests sent to the server whenever the action is associated with user provided data.

8. Method of claim 7, including the steps of:
checking the conditions on any of the monitors in the monitor vector, after every action to see if the trigger conditions are met;
after the all the actions have been repeated, checking the trigger conditions for the compound monitors that involve multiple pages;
for every action that is triggered, checking the notification options, and sending alerts based on the notification options that are defined.

9. Method of claim 7, wherein the sequence of action is repeated visually for the user to see and confirm, automatically without any user intervention but the user is allowed to control the time delay between the time actions by controlling one parameter and user can allow a break point to be inserted and during subsequent repetitions of that sequence, an option to pause the repetition at the break point

10. Method of claim 7, wherein the sequence of action is repeated visually for the user to see and confirm, but the user can manually go to the next action by interacting with the user interface.

11. Method of claim 7, wherein the user can initiate a new learning while the sequence is being repeated and the process consisting steps of:
start the capture process when user indicates desire to do so by interacting with the user interface;
copying all subsequent actions and data vector under the newly saved sequence;
stop learning and saving into the newly saved sequence when the user indicates to do so through the user interface.
saving the all the data vectors and monitors associated with all the actions together with this sequence.

12. Method of claim 7, wherein the stored sequence to be repeated is located in the database using a sequence search facility that supports search through hierarchical categories, or through re-ordering of stored sequences based on date, title, or URL, or searching through user provided keywords, or urls.

13. Method of claim 7, wherein the repetition of the sequence being repeated that has a form element indicated as variable will be paused automatically at the point where that form element exists and that form element will be highlight so that the user can provide that element manually.

14. Method of claim 7, wherein a particular action or a group of actions within a sequence are repeated if the monitors indicates to do so.

15. A method of claim 7, wherein the entire sequence is repeated automatically without any user interaction by reading the actions and data vector already stored in the file, the method comprising the steps of:
reading the actions, data vector and monitors associated with the sequence;
invoking the same type of actions that user originally invoked;
populating the data read from data vector into requests sent to the server whenever the action is associated with user provided data.

16. Method of claim 15, wherein a scheduler determines the time when a sequence or a group of sequences is to be repeated, and the configuration of this scheduler includes steps of:
define tasks by selecting one or more sequences through browsing or searching the sequence database;
associating a schedule to each task using the one or more of the following options: 1) run only once at a specific time and data, 2) run periodically after every configured number of minutes, 3) run on specific days of the week at specified times, every week, 4) monthly on a specified day at specified time, and 5) run yearly on specified time and day.

17. Method of claim 15, wherein a sequence is repeated because the scheduling conditions are met in any of the monitors associated with every action in that sequence, and this includes steps of:
continuously visiting every sequence in the database and checking the scheduling conditions on the monitor;
when the monitor indicates that it is time to monitor the corresponding element inside that sequence, the sequence is placed on a queue of to-be-repeated sequences;
continuously visiting the queue of to-be-repeated sequences and running the sequences one after the other.

18. Method of claim 15, wherein the repetition of the sequence being repeated that has a form element indicated as variable will read a new value of that variable every time it is repeated.

19. Method of claim 1, including steps of merging multiple sequences into a single sequences in such a way that the merged sequence contains its own copy of the entire information of all of the original sequences.

20. Method of claim 1, including the steps of allowing user to edit the sequence visually so user can remove specific action or multi-selected group of actions from the sequence, transfer specific action or multi-selected group of actions from other sequences, and merge multiple sequences into a single sequence.
